(19) United States
(12) Patent Application Publication
(10) Pub. No.: US 2005/0022929 A1
(43) Pub. Date: Feb. 3, 2005

(54) Multi-phase structural adhesives

(76) Inventors: Rainer Schoenfeld, Duesseldorf (DE); Hubert Schumann, Sandhausen (DE)

Correspondence Address: HENKEL CORPORATION, THE TRIAD, SUITE 200, 2200 RENAISSANCE BLVD., GULPH MILLS, PA, 19406, US

(21) Appl. No.: 10/867,652

(22) Filed: Jun. 15, 2004

Related U.S. Application Data
(63) Continuation of application No. PCT/EP02/14224, filed on Dec. 13, 2002.

(30) Foreign Application Priority Data
Dec. 22, 2001 (DE) 101 63 859.0

(51) Int. Cl. B32B 31/00

(52) U.S. Cl. 156/272.2; 525/523

(57) ABSTRACT

Hot-curing structural adhesives with multiphase polymer morphology, wherein the binder matrix of the cured chemically reactive adhesive displays
(a) a continuous phase containing a polymer P1 having a glass transition temperature of over 100° C.;
(b) a heterodisperse phase consisting of individual continuous domains of a thermoplastic or elastomeric polymer P2 having a glass transition temperature of below −30° C. and an average particle size of between 0.5 and 50 μm, which itself contains separate phases of another thermoplastic or elastomeric polymer P3 having a glass transition temperature of below −30° C. and a size of between 1 nm and 100 nm, parts of which can be in aggregated form as larger agglomerates; and
(c) another heterodisperse phase embedded in the continuous phase and consisting of domains of the polymer P3, at least parts of which have an average particle size of between 1 nm and 50 nm, wherein P3 is not identical to P2; are suitable as high-strength, impact resistant structural adhesives, for internal stiffeners for cavities in automobile construction and for the production of reinforcing coatings for thin-wall sheet components.

### CROSS-REFERENCE TO RELATED APPLICATIONS

This application is a continuation under 35 USC Sections 365(c) and 120 of International Application No. PCT/EP02/14224 filed 13 Dec. 2002 and published 10 Jul. 2003 as WO 03/055957, which claims priority from German Application No. 10163859.0, filed 22 Dec. 2001, each of which is incorporated herein by reference in its entirety.

### FIELD OF THE INVENTION

The present invention concerns reactive structural adhesives with multiphase polymer morphology and their use in automobile construction, aircraft construction or rail vehicle construction.

### DISCUSSION OF THE RELATED ART

In machine, vehicle or equipment construction, particularly in aircraft construction, rail vehicle construction or automobile construction, component parts made from various metal components and/or composite materials are increasingly assembled with the aid of adhesives. For structural bonds with high strength requirements, hot-curing high-strength reactive adhesives (structural adhesives) are widely used, particularly in the form of hot-curing one-component adhesives, which are commonly also formulated as reactive hot melt adhesives. Reactive hot melt adhesives are adhesives that are solid at room temperature and soften at temperatures of up to around 80 to 90° C. and behave in the same way as a thermoplastic material. Only at higher temperatures from around 100° C. are the latent hardeners present in these hot melt adhesives thermally activated, leading to irreversible curing to form a thermoset material. In order to join components, e.g., in the automotive industry, the adhesive is first applied warm to at least one substrate surface, the components to be bonded are then joined together. The adhesive then sets as it cools and through this physical setting it develops an adequate handling strength, i.e., a temporary bond. The components joined together in this way then undergo further treatment in the various washing, phosphating and dip coating baths. Only then is the adhesive cured in an oven at elevated temperatures.

Conventional high-strength reactive adhesives are hard and brittle in the cured state. The bonded joints obtained with them generally display very high shear strength. However, under peel, impact or impact peel stress, especially at low temperatures, the brittle behavior of the highly crosslinked polymers dominates, such that exposure of the bonded joint to this type of stress leads to loss of bonding without substantial energy absorption. The brittleness of the material can be reduced by lowering the glass transition temperature and/or the crosslinking density, although this necessarily leads to a reduction in shear strength, particularly at high temperatures. One conventional method for impact modification of high-strength reactive adhesives is the production of a two-phase polymer morphology with a micro-heterodisperse phase comprising a thermoplastic or elastomeric polymer having a low glass transition temperature of below −20° C. in a continuous matrix of a polymer having a high glass transition temperature of above 100° C. Discrete spherical soft phase domains having diameters of between 0.1 and 10 μm are generally present in the matrix in a homogeneous distribution. One conventional method for producing such two-phase morphologies, e.g., in epoxy resin adhesives, is the addition of a terminal group-modified, epoxy-reactive polybutadiene-co-acrylonitrile copolymer to the uncured epoxy resin. The thermoplastic polymer must be soluble in the uncured epoxy resin but be incompatible with the epoxy resin polymer during the course of the curing reaction, such that phase separation occurs during curing. The phase separation process is stopped when the gel point is reached, such that the thermoplastic or elastomeric polymer is present in the epoxy resin matrix in the form of microscopic spherical domains. Another conventional method for producing such polymer morphologies is the use of powdered core/shell polymers, the primary particles of which are generally between 0.1 and 10 μm in size and whose core polymer displays a low glass transition temperature of below −20° C. A continuous polymer matrix containing microscopic, spherical soft phase domains is obtained in this way. Such adhesive compositions generally also contain inorganic fillers and rheology aids, which are present in the polymer matrix in heterodisperse form but do not make a substantial contribution to the impact modification of the adhesive.

Energy dissipation in such two-phase polymers substantially occurs through plastic deformation of the hard polymer matrix at the interface with the micro-soft phases due to local stress peaks and cavitation around the soft phases. The impact strength of such polymers generally rises as the volume fraction of the soft phase increases. The maximum proportion of soft phase that can be achieved is restricted by phase inversion or loss of mechanical strength. The influence of the soft phase domain size on the impact strength of two-phase polymers is only slight and is not consistent.

Although epoxy resin polymers, for example, with such morphologies already display a marked improvement over the homogeneous epoxy resin polymers in terms of their impact strength with comparable shear strength, their performance when exposed to peel or impact peel stresses is still inadequate.

A modified polymer morphology was described by Buchholz and Mülhaupt, see e.g. R. Mülhaupt, U. Buchholz in “Toughened Plastics II”; Adv. Chem. Ser. 252, American Chemical Society, Washington, D.C., 1996, p. 75 to 94. This was produced by dicyandiamide curing of a mixture of an epoxy resin with a liquid rubber blend comprising a bisphenol-terminated polyurethane and an epoxy-terminated poly(butadiene-co-acrylonitrile). A continuous matrix of an epoxy resin polymer with a glass transition temperature of 80 to 100° C. is obtained in this way, containing two-phase soft phase domains consisting of two different thermoplastic or elastomeric polymers having low glass transition temperatures and diameters of over 1 μm. This polymer morphology displays no other discrete soft phase domains that are visible under a transmission electron microscope (TEM). However, part of a thermoplastic polymer is incorporated homogeneously into the epoxy resin matrix, which leads to a fall in the glass transition temperature of the matrix. This leads to a reduction in strength at high temperatures of over 80° C.

Hot melt adhesive compositions, which are composed of a blend of several epoxy resins, a phenolic resin and a polyurethane-epoxy adduct, are also known from EP-A-0 343 676. The polyurethane-epoxy adduct component consists of a reaction product of several polyalkylene glycol homopolymers and copolymers with primary and secondary OH groups, a diisocyanate and at least one epoxy resin. It is stated that this hot melt adhesive composition displays improved shear strength, peel strength and impact strength in comparison to various commercial one-component hot melt adhesive compositions, but no mention is made of the adhesive properties of the cured bonded joint at low temperatures.

U.S. Pat. No. 5,290,857 describes an epoxy resin adhesive composition containing an epoxy resin and a powdered core/shell polymer and a heat-activatable hardener for the epoxy resin. The powdered core/shell polymer consists of a core containing an acrylate or methacrylate polymer having a glass transition temperature of −30° C. or lower and a shell containing an acrylate or methacrylate polymer that contains crosslinking monomer units and whose glass transition temperature is greater than or equal to 70° C., wherein the weight ratio of the core to the shell is in the range between 10:1 and 1:4. It is stated that these compositions have excellent adhesive properties such as impact strength, shear strength and T-peel strength and also possess a good partial gelling capacity. No mention is made of the properties of bonded joints with these adhesives at low temperatures.

Similarly U.S. Pat. No. 5,686,509 describes an adhesion-reinforcing composition for epoxy resins consisting of powdered copolymer particles, which are ionically crosslinked with a monovalent or divalent metal cation. The core area of the core/shell polymer is composed of a diene monomer and optionally crosslinking monomer units and has a glass transition temperature of less than or equal to −30° C. The shell copolymer has a glass transition temperature of at least 70° C. and is composed of acrylate or methacrylate monomer units and radically polymerizable unsaturated carboxylic acid units. The adhesive composition should contain 15 to 60 parts by weight of the adhesion-reinforcing copolymer powder and 3 to 30 parts by weight of a heat-activable curing agent for every 100 parts of epoxy resin. These compositions are recommended for use as structural adhesives for automotive parts. No mention is made of the low-temperature properties of such bonded joints.

Epoxy resin compositions are known from EP-A-0 308 664 that contain an epoxy adduct of a carboxyl group-containing copolymer based on butadiene acrylonitrile or similar butadiene copolymers together with a reaction product of an elastomeric prepolymer, which has terminal isocyanate groups and is soluble or dispersible in epoxy resins, with a polyphenol or aminophenol, with subsequent reaction of this adduct with an epoxy resin. These compositions can also contain one or more epoxy resins. Amino-functional hardeners, polyaminoamides, polyphenols, polycarboxylic acids and anhydrides thereof or catalytic hardeners and optionally accelerators are further proposed for curing of these compositions. It is stated that these compositions are suitable as adhesives, which depending on the specific composition can display high strength, high glass transition temperature, high peel strength, high impact strength or high crack propagation resistance.

Similarly, EP-A-0 353 190 describes epoxy resin compositions containing an adduct comprising an epoxy resin and a carboxylated butadiene-acrylonitrile copolymer together with a reaction product of a hydroxyl-, mercapto- or amino-terminated polyalkylene glycol with a phenolic benzoic acid, with subsequent reaction of the phenolic group with an epoxy resin. It can be inferred from EP-A-0 353 190 that these compositions are suitable for producing adhesives, film adhesives, patches, sealants, paints or matrix resins.

EP-A-338985 describes modified epoxy resins containing a liquid copolymer based on butadiene, a polar, ethylenically unsaturated comonomer and optionally other ethylenically unsaturated comonomers and also a reaction product consisting of dihydroxy-terminated or diamino-terminated polyalkylene glycols and diisocyanates along with a monophenol, a mercapto alcohol or an aliphatic lactam. According to the teaching of this document these compositions can be used for the flexibilization of epoxy resins. In addition to the aforementioned constituents, these compositions should also contain epoxy resins and a hardener or accelerator. Such mixtures are to be used as adhesives, film adhesives, patches, matrix resins, paints or sealants.

EP-A-366157 describes epoxy resins containing polyesters based on polyalkylene glycol and hardeners that are effective at elevated temperatures. These compositions contain at least one compound having at least one 1,2-epoxy group in the molecule together with a reaction product of an aliphatic or cycloaliphatic diol with an aromatic hydroxycarboxylic acid and a hardener for the epoxy group-containing compound that is effective at elevated temperatures. It is stated that the cured epoxy resin mixtures should display a very good low-temperature flexibility and corrosion resistance. No mention is made of their suitability as adhesives with high peel strength at low temperatures, particularly under impact stress.

EP-A-272222 describes epoxy resins containing polyesters based on polyalkylene glycol. These polyesters are derived from aliphatic, cycloaliphatic or aromatic carboxylic acids and/or aromatic hydroxycarboxylic acids and aliphatic or cycloaliphatic diols, wherein at least 70 wt. % of the carboxylic acid derivatives derive from dimeric and/or trimeric fatty acids. It is stated that such epoxy resin compositions are suitable for the preparation of hot-curing adhesives for the bonding of steel and aluminum substrates. The cured epoxy resin mixtures are said to display a good low-temperature flexibility and corrosion resistance.

Water-insoluble compounds are known from EP-A-307666 which are substantially free from isocyanate groups and display at least two free phenolic hydroxyl groups per molecule and which are obtainable by reacting a prepolymeric polyisocyanate that is an adduct of a polyisocyanate to a prepolymeric polyhydroxyl or polysulfhydryl compound or is derived from a prepolymeric polyether amine. This prepolymeric polyisocyanate is reacted with at least one phenol having two or three phenolic hydroxyl groups or with an aminophenol having one or two phenolic hydroxyl groups. Epoxy resins and heat-activable hardeners are then added to these compounds in order for them to be able to be used as adhesives. Details of their low-temperature performance, especially under impact stress, cannot be inferred from this document.

EP-A-381625 describes curable compositions containing an epoxy resin, a hardener that can be activated at elevated temperature, a liquid copolymer based on butadiene, acrylonitrile and optionally other ethylenically unsaturated comonomers and a segmented copolymer consisting substantially of repeating soft segments with polypropylene glycol or polybutylene glycol units and selected hard segments with a softening point of over 25° C. According to the teaching of this document the segmented copolymers are synthesized from polyether diols based on polypropylene glycol, polytetramethylene glycol or amino-terminated polyether diols and saturated aliphatic dicarboxylic acids with 4 to 12 carbon atoms or aromatic dicarboxylic acids with 8 to 12 carbon atoms and can also contain short-chain diols or diamines in their hard segment. According to the teaching of this document these compositions are suitable as adhesives, particularly as hot melt adhesives and as matrix resins or as surface coating agents. Strengths, particularly peel strengths under impact stress and at low temperature, are not disclosed.

According to the teaching of EP-A-0 354 498 or EP-A-0 591 307 reactive hot melt adhesive compositions can be produced from a resin component, at least one heat-activable latent hardener for the resin component and optionally accelerators, fillers, thixotropic agents and other conventional additives, wherein the resin component is obtainable by reacting an epoxy resin that is solid at room temperature and an epoxy resin that is liquid at room temperature with one or more linear or branched polyoxypropylene(s) having amino terminal groups. The epoxy resins should be used in a quantity relative to the amino-terminated polyoxypropylene such that an excess of epoxy groups relative to the amino groups is ensured. These adhesive compositions already display a high peel resistance in the T-peel test, which is retained even at low temperatures.

DE-A-19845607 describes condensation products obtained from carboxylic dianhydrides, diamines or polyamines, in particular polyoxyalkylene amides and polyphenols or aminophenols and their suitability as a structural component for epoxy resin compositions. Compositions synthesized in this way additionally contain rubber-modified epoxy resins and liquid and/or solid polyepoxies as well as conventional latent hardeners and accelerators and optionally fillers. They are suitable as impact resistant, impact peel resistant and peel resistant adhesives in automotive construction. Although these adhesive compositions on the whole already have a good range of properties even at low temperatures, there is still a need for new and improved adhesive compositions for these fields of application.

PCT/EP01/03699 describes condensation products obtained from cyclic carboxylic anhydrides of dicarboxylic acids, tricarboxylic anhydrides or tetracarboxylic anhydrides and difunctional polyamines, particularly polyoxyalkylene amines, which are suitable as structural components for epoxy resin compositions. The condensation products based on tricarboxylic anhydrides or tetracarboxylic anhydrides should be characterized by on average more than one imide group and carboxyl group per molecule. According to this document condensation products obtained from trifunctional or polyfunctional polyols and/or trifunctional or polyfunctional amino-terminated polymers and cyclic carboxylic anhydrides can optionally also be included in the compositions, wherein the last-named reaction products should contain on average more than one carboxyl group per molecule. These compositions should additionally contain conventional rubber-modified epoxy resins as well as liquid and/or solid polyepoxy resins and conventional hardeners and accelerators and optionally fillers and rheology aids. According to the information in this document such compositions are suitable in particular as impact resistant, impact peel resistant and peel resistant adhesives in automotive construction and electronics. These adhesives are said to display very good impact peel properties at very low temperatures in particular.

Structural adhesives with multiphase polymer morphology are not described in the aforementioned prior art.

### BRIEF SUMMARY OF THE INVENTION

An object of the present invention is further to improve the morphology of cured reactive adhesives to the effect that they display an adequate flexibility and peel strength not only at room temperature but also in particular at low temperatures below 0° C. In particular the peel strength at low temperatures and under impact stress should display as high a value as possible to enable structurally bonded components to comply with current safety requirements in automobile construction even in the event of an accident (crash performance). The polymer morphology should provide these improvements at high temperatures of up to 120° C. without reducing the peel strength and in particular the shear strength.

The present invention provides a hot-curing structural adhesive with multiphase polymer morphology, wherein the binder matrix of the cured chemically reactive adhesive displays a continuous phase consisting of an optionally crosslinked polymer (P1) having a glass transition temperature of over 100° C., preferably 120° C., in which is dispersed a heterodisperse phase consisting of individual continuous domains of a thermoplastic or elastomeric polymer P2 having a glass transition temperature of below −30° C. and an average particle size of between 0.5 and 50 μm.

Another thermoplastic or elastomeric polymer P3 having a glass transition temperature of below −30° C. with average particle sizes of between 1 nm and 100 nm, parts of which can be in aggregated form as larger agglomerates, is dispersed within this phase formed by P2. Furthermore, another heterodisperse phase consisting of domains of the thermoplastic or elastomeric polymer P3 having a glass transition temperature of below −30° C., at least parts of which display an average particle size of between 1 nm and 50 nm, is dispersed in the continuous phase P1, wherein P3 is not identical to P2.

### BRIEF DESCRIPTION OF THE DRAWINGS

FIGS. 1 and 2 are transmission electron micrographs of an embodiment of the hot-curing structural adhesive of the present invention, in cured form

### DETAILED DESCRIPTION OF CERTAIN PREFERRED EMBODIMENTS OF THE INVENTION

In a preferred embodiment the continuous phase of the polymer P1 is formed by an epoxy resin displaying on average more than one epoxy group per molecule. The thermoplastic or elastomeric polymer P2 is preferably a reaction product that can be produced from a difunctional amino-terminated polymer and a tricarboxylic or tetracarboxylic anhydride, wherein this reaction product displays on average more than one imide group and carboxyl group per molecule. This reaction product is preferably then reacted with an excess of a liquid epoxy resin. The polymer P2 can also be formed from a reaction product that can be produced from a trifunctional or polyfunctional polyol or a trifunctional or polyfunctional amino-terminated polymer and a cyclic carboxylic anhydride, wherein the reaction product contains on average more than one carboxyl group per molecule. This reaction product too is preferably reacted with a large excess of a liquid epoxy resin. The polymer P2 can also be formed from a mixture of both of the aforementioned reaction products.

The thermoplastic or elastomeric polymer P3 is a butadiene-based copolymer, a reaction product of a carboxyl group-containing copolymer based on butadiene acrylonitrile, butadiene (meth)acrylic acid ester, butadiene acrylonitrile styrene copolymer, butadiene (meth)acrylate styrene copolymers or a dendrimer with a liquid epoxy resin.

A large number of polyepoxies having at least two 1,2-epoxy groups per molecule are suitable as epoxy resins for the continuous phase of the polymer P1 and for forming the epoxy adduct or for mixing or reacting with the thermoplastic polymers P2 and P3. The epoxy equivalent weight of these polyepoxies can vary between 150 and 4000. The polyepoxies can in principle be saturated, unsaturated, cyclic or acyclic, aliphatic, alicyclic, aromatic or heterocyclic polyepoxy compounds. Examples of suitable polyepoxies include the polyglycidyl ethers produced by reacting epichlorohydrin or epibromohydrin with a polyphenol in the presence of alkali. Suitable polyphenols for this purpose are for example resorcinol, catechol, hydroquinone, bisphenol A (bis(4-hydroxyphenyl)-2,2-propane)), bisphenol F (bis(4-hydroxyphenyl) methane), bis(4-hydroxyphenyl)-1,1-isobutane, 4,4′-dihydroxybenzophenone, bis(4-hydroxyphenyl)-1,1-ethane and 1,5-hydroxynaphthalene.

Other polyepoxies that are suitable in principle are the polyglycidyl ethers of polyalcohols or diamines. These polyglycidyl ethers are derived from polyalcohols such as ethylene glycol, diethylene glycol, triethylene glycol, 1,2-propylene glycol, 1,4-butylene glycol, triethylene glycol, 1,5-pentane diol, 1,6-hexane diol or trimethylol propane.

Other polyepoxies are polyglycidyl esters of polycarboxylic acids, for example reactions of glycidol or epichlorohydrin with aliphatic or aromatic polycarboxylic acids such as oxalic acid, succinic acid, glutaric acid, terephthalic acid or dimeric fatty acid.

Other epoxies are derived from the epoxidation products of olefinically unsaturated cycloaliphatic compounds or from native oils and fats.

The epoxy resins derived by reacting bisphenol A or bisphenol F and epichlorohydrin (DGEBA or DGEBF) are most particularly preferred. Mixtures of liquid and solid epoxy resins are generally used, wherein the liquid epoxy resins are preferably based on bisphenol A and display an adequately low molecular weight. Epoxy resins that are liquid at room temperature are used in particular for adduct formation with components P2 and P3, wherein they generally have an epoxy equivalent weight of 150 to approximately 220, an epoxy equivalent weight range of 182 to 192 being particularly preferred.

The difunctional amino-terminated polymers used for the condensation product P2 can preferably be amino-terminated polyalkylene glycols, particularly the difunctional amino-terminated polypropylene glycols, polyethylene glycols or copolymers of propylene glycol and ethylene glycol. These are also known under the name “Jeffamine” (trade name of Huntsman Chemical Company). Also suitable are the difunctional amino-terminated polyoxytetramethylene glycols, also known as poly-THF. Difunctional amino-terminated polybutadiene compounds are also suitable as structural components, as are aminobenzoic acid esters of polypropylene glycols, polyethylene glycols or poly-THF (known under the trade name “Versalink oligomeric diamines” from Air Products & Chemicals). The amino-terminated polyalkylene glycols or polybutadienes have molecular weights of between 400 and 6000.

If the aforementioned difunctional amino-terminated polymers are reacted with aliphatic tricarboxylic anhydrides such as e.g. citric anhydride, 1,2,3-propane tricarboxylic anhydride or aconitic anhydride, imide structures having free carboxyl groups at the imide ring are produced.

If aromatic tricarboxylic anhydrides or tetracarboxylic anhydrides are reacted, imide structures having free carboxyl groups at the aromatic ring are produced. Examples of aromatic tricarboxylic or tetracarboxylic anhydrides that can be used are 1,2,3- or 1,2,4-benzenetricarboxylic anhydride, mellophanic, pyromellitic, 1,8:4,5- or 2,3:6,7-naphthalene tetracarboxylic or perylene dianhydride, biphenyl tetracarboxylic, diphenyl ether tetracarboxylic, diphenylmethane tetracarboxylic, 2,2-diphenylpropane tetracarboxylic or benzophenone tetracarboxylic dianhydride, diphenylsulfone tetracarboxylic dianhydride or mixtures thereof.

Trifunctional or polyfunctional amino-terminated polymers can also be used for the reaction product P2, wherein tricarboxylic or tetracarboxylic anhydrides are preferably used as the second component such that cyclic imide structures are produced. If carboxylic anhydrides produced from dicarboxylic acids are used, the condensation reaction should be controlled in such a way that open-chain amide structures having free carboxyl groups are produced.

Specific examples of carboxylic anhydrides are maleic, succinic, citric, 1,2,3-propane tricarboxylic, aconitic, phthalic or 1,2,3- or 1,2,4-benzenetricarboxylic anhydride, mellophanic, pyromellitic, 1,8:4,5- or 2,3:6,7-naphthalene tetracarboxylic or perylene dianhydride, biphenyl tetracarboxylic, diphenyl ether tetracarboxylic, diphenylmethane tetracarboxylic, 2,2-diphenylpropane tetracarboxylic or benzophenone tetracarboxylic dianhydride, diphenyl sulfone tetracarboxylic dianhydride or mixtures thereof.

Examples of the copolymers in structural component P3 are 1,3-diene polymers with carboxyl groups and other polar, ethylenically unsaturated comonomers. Butadiene, isoprene or chloroprene can be used as diene, while butadiene is preferred. Examples of polar, ethylenically unsaturated comonomers are acrylic acid, methacrylic acid, low alkyl esters of acrylic or methacrylic acid, for example methyl or ethyl esters thereof, amides of acrylic or methacrylic acid, fumaric acid, itaconic acid, maleic acid or low alkyl esters or semiesters thereof, or maleic or itaconic anhydride, vinyl esters such as, e.g., vinyl acetate or in particular acrylonitrile or methacrylonitrile. Most particularly preferred copolymers A) are carboxyl-terminated butadiene acrylonitrile copolymers (CTBN), which are sold in liquid form under the trade name “Hycar” by B. F. Goodrich. These have molecular weights of between 2000 and 5000 and acrylonitrile contents of between 10% and 30%. Specific examples are HYCAR CTBN 1300×8, 1300×13 or 1300×15.

The core/shell polymers known from U.S. Pat. No. 5,290,857 or from U.S. Pat. No. 5,686,509 can also be used as structural component P3. The core monomers should have a glass transition temperature of less than or equal to −30° C., these monomers can be selected from the group of the aforementioned diene monomers or suitable acrylate or methacrylate monomers and the core polymer can optionally contain small quantities of crosslinking comonomer units. The shell is synthesized from copolymers having a glass transition temperature of at least 60° C. The shell preferably consists of low alkyl acrylate or methacrylate monomer units (methyl or ethyl ester) and polar monomers such as (meth)acrylonitrile, (meth)acrylamide, styrene or radically polymerizable unsaturated carboxylic acids or carboxylic anhydrides.

A further possibility for the structural component P3 is the use of dendrimers, which are also known as dendritic polymers, cascade polymers or “starburst” polymers. They are known to be synthesized stepwise by bonding two or more monomers to each monomer that has already been bonded, so that with each step the number of monomer terminal groups increases exponentially and a spherical tree structure is ultimately formed. Such dendrimers can be produced for example by Michael addition of acrylic acid methyl ester to ammonia or amines.

The adducts of epoxy resins and the aforementioned liquid CTBN rubbers, however, are particularly preferred for the structural component P3.

Guanidines, substituted guanidines, substituted ureas., melamine resins, guanamine derivatives, cyclic tertiary amines, aromatic amines and/or mixtures thereof can be used as heat-activable or latent hardeners for the epoxy resin binder system comprising components P1, P2 and P3. The hardeners can be included stoichiometrically in the curing reaction, but they can also be catalytically active. Examples of substituted guanidines are methyl guanidine, dimethyl guanidine, trimethyl guanidine, tetramethyl guanidine, methyl isobiguanidine, dimethyl isobiguanidine, tetramethyl isobiguanidine, hexamethyl isobiguanidine, heptamethyl isobiguanidine and most particularly cyanoguanidine (dicyandiamide). Alkylated benzoguanamine resins, benzoguanamine resins or methoxymethyl ethoxymethyl benzoguanamine can be cited as representatives of suitable guanamine derivatives. The selection criterion for the one-component, hot-curing hot melt adhesives is naturally the low solubility of these substances in the resin system at room temperature, so solid, finely ground hardeners have the advantage here, dicyandiamide being particularly suitable. This ensures that the composition has good storage stability.

Catalytically active substituted ureas can be used in addition to or in place of the aforementioned hardeners. These are in particular p-chlorophenyl-N,N-dimethyl urea (monuron), 3-phenyl-1,1-dimethyl urea (fenuron) or 3,4-dichlorophenyl-N,N-dimethyl urea (diuron). Catalytically active tertiary aryl or alkyl amines, such as, e.g., benzyl dimethylamine, tris(dimethylamino)phenol, piperidine or piperidine derivatives, can also be used in principle, although many of these have too high a solubility in the adhesive system, such that in this case no practical storage stability can be achieved for the one-component system. Various imidazole derivatives, preferably solid examples, can also be used as catalytically active accelerators. 2-ethyl-2-methyl imidazole, N-butyl imidazole, benzimidazole and N—Cl to C12 alkyl imidazoles or N-aryl imidazoles can be cited as representatives.

The adhesives according to the invention generally also contain fillers known per se such as for example the various ground or precipitated chalks, carbon black, calcium magnesium carbonates, barytes and in particular siliceous fillers of the aluminum magnesium calcium silicate type, e.g., wollastonite, chlorite.

The adhesive compositions according to the invention can also contain other conventional auxiliary substances and additives such as, e.g., plasticizers, reactive thinners, rheology aids, wetting agents, antioxidants, stabilizers and/or colored pigments.

As already mentioned in the introduction, the demands on modern structural adhesives in automotive construction are continually increasing, since more and more components, even those of a load-bearing nature, are joined by bonding processes. As already stated in the work by G. Kötting and S. Singh, “Anforderungen an Klebstoffe für Strukturverbindungen im Karosseriebau”, Adhesion 1988, no. 9, page 19 to 26, the adhesives must firstly satisfy aspects of production that are of practical significance, including automatable processing in short cycle times, adhesion to oiled sheet metals, adhesion to various types of sheet metal and compatibility with process conditions on the painting line (resistance to washing and phosphating baths, curable during stoving of the CEC primer, resistance to the subsequent painting and drying operations). Modern structural adhesives must moreover meet rising strength and deformation criteria in the cured state too. These include high corrosion resistance or flexural strength of the structural components and deformability of the bonded joint under mechanical stress. As high a deformability of the components as possible ensures a considerable safety advantage under impact stress (crash performance) in the event of an accident. This performance can be determined most effectively by determining the impact energy for cured bonded joints, whereby adequately high values for impact energy or impact peel energy are desirable or necessary both at high temperatures of up to +90° C. and in particular at low temperatures of down to −40° C. As high a shear strength as possible should also be achieved. Both strengths must be achieved on a large number of substrates, principally oiled sheet metals, such as e.g. automobile body sheet, sheet steel galvanized by a wide range of methods, sheet metals made from various aluminum alloys or magnesium alloys and sheet steels coated with organic coatings such as those sold by Henkel KGaA under the trade names “Bonazinc” and “Granocoat” for use in coil coating. As will be demonstrated in the examples below, the adhesive compositions according to the invention surprisingly satisfy these requirements to a very great extent.

The examples below are intended to illustrate the invention in more detail. All quantities in the compositions are given as parts by weight unless otherwise stated.

### EMBODIMENT EXAMPLE

Production of Polymer P2

3.1 mol of maleic anhydride was reacted under a nitrogen atmosphere with 1 mol of JEFFAMINE XTJ-509 (trivalent aminno-terminated polypropylene oxide) at 120° C. for 120 min whilst being stirred. The reaction product is reacted with 2.3 times its mass of a liquid DGEBA epoxy resin and 0.25 wt. % triphenyl phosphine for 90 min at 100° C.

Production of Polymer P3

HYCAR CTBN 1300×13 (carboxy-terminated poly(butadiene co-acrylonitrile) was reacted under a nitrogen atmosphere at 140° C. with around a ten-times molar excess of a liquid DGEBA epoxy resin for 3 hours with stirring until reaction constancy. The product containing 40% butyl rubber displays an epoxy equivalent weight of 900 and a viscosity of 200 Pa.s at 80° C.

Production of the Adhesive

165 g P2, 55 g P3, 2 g DGEBA, 17.5 g dicyandiamide, 0.25 g fenuron and optionally 10 g CABOSIL TS 720 silica were mixed at 70° C. until homogeneous and then transferred to storage containers whilst still warm.

After curing (30 min at 180° C.) the adhesive displays the morphology according to the invention, as can be seen from the transmission electron micrographs (TEM).

The table compares the adhesive properties of the example according to the invention with the adhesive properties of an adhesive according to the prior art. The adhesive used for the comparative test is TEROKAL 5051 from Henkel Teroson. This adhesive displays a two-phase morphology with a micro-heterodisperse phase comprising an elastomeric polymer having a low glass transition temperature of below 40° C. in a continuous highly crosslinked epoxy resin matrix having a high glass transition temperature of over 120° C. Discrete spherical soft phase domains having diameters of between 0.5 and 2 μm are homogeneously distributed in the matrix.

| Example | Invention | Comparison |
|---|---|---|
| Impact −40° C. [J] | 14.3 | 0.5 |
| Impact −20° C. [J] | 15.8 | 0.4 |
| Impact 0° C. [J] | 17.7 | 0.9 |
| Impact 23° C. [J] | 22.8 | 2.1 |
| SS 23° C. [MPa] | 37 | 21.8 |
| SS 90° C. [MPa] | 24 | 10.9 |

The example according to the invention displays very high impact peel strength (impact) to ISO 11343 even at high impact speeds. This is particularly evident from the high impact peel energy values at the low temperatures of −20° C. and −40° C. At the same time these compositions display high shear strength (SS) to DIN 53283 even at high temperatures of 90° C. and in terms of both values are far superior to the compositions according to the present prior art.

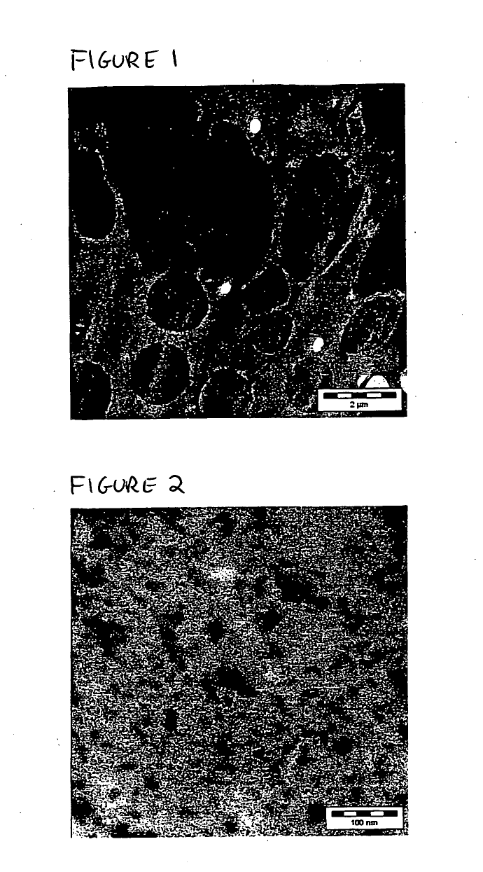

FIGS. 1 and 2 are transmission electron micrographs of the embodiment example (without CABOSIL TS 720 silica) in various magnifications. Castings measuring 14×7×4 mm3 were cured at 180° C. for 30 min, contrasted with OsO4 and ultramicrotome sections prepared.

1. A hot-curing structural adhesive with multiphase polymer morphology, said adhesive when cured comprising a binder matrix comprising:
a) a continuous phase comprising an optionally crosslinked polymer P1 having a glass transition temperature of over 100° C.;
b) a first heterodisperse phase comprising individual continuous domains of a thermoplastic or elastomeric polymer P2 having a glass transition temperature of below −30° C. and an average particle size of between 0.5 and 50 μm and containing separate phases of another thermoplastic or elastomeric polymer P3 having a glass transition temperature of below −30° C. and a size of between 1 nm and 100 nm, parts of which can be in aggregated form as larger agglomerates; and
c) a second heterodisperse phase embedded in the continuous phase and comprising domains of the thermoplastic or elastomeric polymer P3, at least parts of which have an average particle size of between 1 nm and 50 nm, wherein P3 is not identical to P2.

2. The hot-curing structural adhesive as claimed in claim 1, wherein the continuous phase of the polymer P1 is formed from at least one epoxy resin having on average more than one epoxy group per molecule.

3. The hot-curing structural adhesive as claimed in claim 1, wherein the polymer P2 is selected from the group consisting of:
a) reaction products of (i) difunctional amino-terminated polymers and (ii) tricarboxylic and/or tetracarboxylic anhydrides, wherein the reaction product contains on average more than one imide group and carboxyl group per molecule;
b) reaction products of (i) trifunctional polyols, polyfunctional polyols, trifunctional amino-terminated polymers and/or polyfunctional amino-terminated polymers and (ii) cyclic carboxylic anhydrides, wherein the reaction product contains on average more than one carboxyl group per molecule;
c) adducts of (i) the reaction products according to (a) and (b) and (ii) one or more epoxy resins; and
d) mixtures of two or more of (a), (b), and (c).

4. The hot-curing structural adhesive as claimed in claim 1, wherein the polymer P3 is a butadiene-based copolymer.

5. The hot-curing structural adhesive as claimed in claim 1, wherein the polymer P3 comprises a carboxyl group-containing copolymer based on one or more polymers selected from the group consisting of butadiene acrylonitrile copolymers, butadiene (meth)acrylic acid ester copolymers, butadiene acrylonitrile styrene copolymers, butadiene (meth)acrylate styrene copolymers and dendrimers.

6. The hot-curing structural adhesive as claimed in claim 1, wherein the polymer P1 has a glass transition temperature of over 120° C.

7. The hot-curing structural adhesive as claimed in claim 1, wherein the continuous phase of the polymer P1 is formed from at least one epoxy resin derived by reacting at least one polyphenol with epichlorohydrin.

8. The hot-curing structural adhesive as claimed in claim 1, wherein the continuous phase of the polymer P1 is formed from at least one epoxy resin selected from the group consisting of diglycidyl ethers of bisphenol A and bisphenol F and having an epoxy equivalent weight of between 150 and 4000.

9. The hot-curing structural adhesive as claimed in claim 1, wherein the polymer P3 is an adduct of a liquid CTBN rubber and an epoxy resin.

10. The hot-curing structural adhesive as claimed in claim 1 wherein the polymer P2 is a reaction product of an amino-terminated polypropylene oxide and a cyclic carboxylic anhydride.

11. The hot-curing structural adhesive as claimed in claim 1, wherein the continuous phase of the polymer P1 is formed from at least one epoxy resin selected from the group consisting of diglycidyl ethers of bisphenol A and bisphenol F, the polymer P2 is a reaction product of an amino-terminated polypropylene oxide and a cyclic carboxylic anhydride, and the polymer P3 is an adduct of a liquid CTBN rubber and an epoxy resin.

12. A process for bonding a first material and a second material, said process comprising:
(a) applying the hot-curing structural adhesive composition according to claim 1 onto at least one surface of at least one of the first material and the second material;
(b) joining together the first material and the second material; and
(c) heating and curing the hot-curing structural adhesive to form a bonded joint between the first material and the second material.

13. The process as claimed in claim 12, wherein the hot curing structural adhesive is pregelled before curing.

14. The process as claimed in claim 12, wherein the hot-curing structural adhesive is heated at a temperature of between 80° C. and 210° C.

15. The process as claimed in claim 12, wherein at least one of the first material and the second material is metallic.

16. A process for reinforcing a thin-wall sheet component, said process comprising:
(a) applying the hot-curing structural adhesive of claim 1 onto at least one surface of the thin-wall sheet component; and
(b) heating and curing the hot-curing structural adhesive to form a reinforcing coating.

17. A process for forming a high-strength, high-impact adhesive, said process comprising heating and curing the hot-curing structural adhesive of claim 1.

18. The process as claimed in claim 17, wherein the hot-curing structural adhesive is heated at a temperature of between 80° C. and 210° C.

19. The process as claimed in claim 17, additionally comprising foaming the hot-curing structural adhesive.
